(19) United States
(12) Patent Application Publication
(10) Pub. No.: US 2014/0265028 A1
(43) Pub. Date: Sep. 18, 2014

(54) METHODS AND APPARATUS FOR FORMING INDICIA ON PANELS

(71) Applicant: HONDA MOTOR CO., LTD., Tokyo (JP)

(72) Inventors: Stephen F. Winter, Florence, SC (US); J. Michael Cole, Columbus, OH (US)

(73) Assignee: HONDA MOTOR CO., LTD., Tokyo (JP)

(21) Appl. No.: 13/803,865

(22) Filed: Mar. 14, 2013

(51) Int. Cl. B29D 99/00; B21D 22/02; B29C 43/02

(52) U.S. Cl. CPC B29D 99/001; B29C 43/021; B21D 22/02
USPC 264/322; 425/324.1; 72/352

(57) ABSTRACT

A die in combination with a panel includes a die and a panel. The die includes a stamping surface and an outer edge. The panel includes an outer surface, and the outer surface includes a recessed portion. The recessed portion includes a contact surface, indicia on the contact surface, and a non-contact surface. The contact surface has a perimeter, and the non-contact surface defines a channel, which is positioned adjacent the perimeter of the contact surface and at least partially surrounds the contact surface. Methods of forming indicia on a panel are also discussed.

### TECHNICAL FIELD

The present application generally relates to methods and apparatus for forming indicia on a panel.

### BACKGROUND

Conventional fender panels of vehicles are known to include indicia.

### SUMMARY

In accordance with one embodiment, a die in combination with a panel includes a die and a panel. The die includes a stamping surface, a non-stamping surface, and a perimeter surface. The stamping surface and the perimeter surface cooperate to define an outer edge. The panel includes an outer surface, and the outer surface includes a recessed portion. The recessed portion includes a contact surface, indicia on the contact surface, and a non-contact surface. The contact surface has a perimeter, and the non-contact surface defines a channel. The channel is positioned adjacent the perimeter of the contact surface and at least partially surrounds the contact surface. When the stamping surface of the die and the contact surface of the panel are at least generally aligned, the outer edge of the die extends beyond the perimeter of the contact surface of the panel and the outer edge of the die is spaced from the non-contact surface of the panel, such that the outer edge of the die is prevented from marking the panel during a hot-stamping process to form the indicia on the contact surface of the panel.

In accordance with another embodiment, a die in combination with a panel includes a die and a panel. The die includes a lower, stamping surface, an upper, non-stamping surface, and a perimeter surface. The lower, stamping surface and the perimeter surface cooperate to define an outer edge. The panel includes an outer surface, and the outer surface includes an upper portion and a recessed portion. The recessed portion extends generally downwardly from the upper portion and includes a contact surface, indicia on the contact surface, and a non-contact surface. The contact surface has a perimeter, and the non-contact surface defines a channel. The channel is positioned adjacent the perimeter of the contact surface and completely surrounds the contact surface. Each of the lower, stamping surface of the die and the contact surface of the panel has a substantially rectangular shape and a length and width. The contact surface is planar and defines an imaginary plane, and the non-contact surface includes an inclined portion. The inclined portion is linear and inclined at an angle ranging from about 100 degrees to about 150 degrees relative to the imaginary plane. The channel has an outer channel perimeter and a channel width. The outer channel perimeter is defined by an intersection of the imaginary plane and the non-contact surface and spaced from the perimeter of the contact surface. The channel width is a distance between the perimeter of the contact surface and the outer channel perimeter and is substantially constant.

In accordance with yet another embodiment, a method of forming indicia on a panel includes forming a recessed portion on an outer surface of a panel. The recessed portion includes a contact surface and a non-contact surface. The non-contact surface defines a channel, and the channel is positioned adjacent the contact surface and at least partially surrounds the contact surface. The method further includes positioning a carrier between the contact surface of the panel and a stamping surface of a die. The contact surface of the panel has a perimeter, and the die includes an outer edge. The method further includes hot stamping indicia onto the contact surface of the panel. The hot stamping includes at least generally aligning the stamping surface of the die with the contact surface of the panel and moving the die and the panel relative to each other, such that the carrier is in contact with each of the stamping surface of the die and the contact surface of the panel and indicia is applied from the carrier to the contact surface of the panel. The method further includes configuring the die such that the outer edge of the die is spaced from the non-contact surface of the panel and the outer edge of the die is prevented from marking the panel during the hot stamping.

### BRIEF DESCRIPTION OF THE DRAWINGS

It is believed that certain embodiments will be better understood from the following description taken in conjunction with the accompanying drawings in which:

FIG. 1 is a rear perspective view depicting a vehicle including a panel in accordance with one embodiment;

FIG. 2 is a schematic, elevation view, partially in cross-section, depicting the panel of FIG. 1 apart from other components of the vehicle, and in combination with a die, a carrier, a supply roller, and a take-up roller;

FIG. 3 is an enlargement of a portion of the arrangement of FIG. 2;

FIG. 4 is a top plan view depicting a recessed portion of the panel of FIG. 1;

FIG. 5 is a cross-sectional view taken along line 5-5 in FIG. 4;

FIG. 6 is a cross-sectional view taken along line 6-6 in FIG. 4;

FIG. 7 is an enlarged view of an encircled portion of FIG. 5; and

FIG. 8 is a bottom plan view depicting a substrate of the die of FIG. 2.

### DETAILED DESCRIPTION

Embodiments are hereinafter described in detail in connection with the views and examples of FIGS. 1-8, wherein like numbers indicate the same or corresponding elements throughout the views. FIG. 1 illustrates a vehicle 10 which is shown to be an all-terrain vehicle (“ATV”). However, a vehicle in accordance with alternative embodiments can be an automobile, a truck, a van, a recreational vehicle, a utility vehicle, a riding lawnmower, agricultural equipment, an aircraft, a watercraft, or construction equipment, for example.

The vehicle 10 can include a frame 12. At least a portion of the frame 12 can include a tubular construction, as shown in FIG. 1. However, it will be appreciated that a frame can be provided in any of a variety of other suitable arrangements, such as a unibody construction, for example. Further, the frame 12 can be formed using any of a variety of materials, such as a metal or carbon fiber, for example. As illustrated in FIG. 1, two pairs of wheels (e.g., 14, 16) can be rotatably coupled with the frame 12. In particular, the vehicle 10 can include a pair of front wheels 14 (one shown) and a pair of rear wheels 16, each rotatably coupled with the frame 12. The pair of front wheels 14 can be steerable wheels. Although the vehicle 10 is shown to be of a type having four wheels (e.g., 14, 16), it will be appreciated that a vehicle can alternatively include more than four wheels or less than four wheels. The vehicle 10 can include an engine (not shown), which can be an internal combustion engine, and/or one or more electric motors (not shown), or any other suitable source of motive power, which can be coupled, via a drivetrain, to the wheels to selectively rotate the wheels, for example, front wheels 14 and/or rear wheels 16. A handlebar assembly 18 can be operably coupled with the pair of front wheels 14 to facilitate steering of the front wheels 14, and as illustrated in FIG. 1, the handlebar assembly 18 can include a right hand grip 20 and a left hand grip 22. The vehicle 10 can further include a saddle-type seat 24 configured to support one or more persons.

The vehicle 10 can also include a body 26, as illustrated in FIG. 1. The body 26 can be supported by the frame 12. The vehicle 10 can include front and rear cargo racks 28, 30 that can be respectively supported at a front end and a rear end of the vehicle 10 by the frame 12 and/or the body 26. The front and rear cargo racks 28, can facilitate support of cargo for transportation by the vehicle 10. Although the front and rear cargo racks 28, 30 are shown in FIG. 1 to include tubular frame assemblies, it will be appreciated that front and rear cargo racks can be configured in any of a variety of suitable alternative arrangements for carrying cargo.

The body 26 can include one or more panels. For example, in one embodiment, and as illustrated in FIG. 1, the body 26 of the vehicle 10 can include a front fender assembly 32, which can include a left, front fender panel 34 and a right, front fender panel 36. The body 26 can also include a rear fender assembly 38, which can include a left, rear fender panel 40 and a right, rear fender panel 42, as illustrated in FIG. 1. In some embodiments, the fender panels (e.g., 34, 36, 40, and 42) can be formed from plastic, but it will be appreciated that a fender panel can be formed from any of a variety of other suitable materials. The left, front fender panel 34 and the right, front fender panel 36 can be formed separately or integrally as a unitary structure. Similarly, the left, rear fender panel 40 and the right, rear fender panel 42 can be formed separately or integrally as a unitary structure. In some embodiments, a fender panel can be considered a workpiece during manufacturing thereof.

It can be desirable to apply various indicia to one or more panels of the body 26. For example, referring to FIGS. 1 and 4, indicia 44 (FIG. 4) can be applied to the left, front fender panel 34. The indicia 44 can provide information, such as, for example, tire pressure specifications.

In one embodiment, indicia 44 can be applied to one or more of the fender panels (e.g., 34, 36, 40, and 42), or any other panels of the vehicle 10, other vehicles, or a device or component thereof that is not a vehicle, using a hot-stamping process. In such an embodiment, a die can selectively interact with a panel to provide indicia. In FIG. 2, for example, the left, front fender panel 34 is shown in combination with a die 46, and a carrier 48 is shown therebetween. Furthermore, the left, front fender panel 34 can be reinforced by a support 47, as illustrated in FIGS. 2-3. During the hot-stamping process, the left, front fender panel 34 and the die 46 can be moved relative to each other, such that the carrier 48 can be in contact with each of the left, front fender panel 34 and the die 46, and the indicia 44 can be applied from the carrier 48 to the left, front fender panel 34. For example, the die 46 can be moved downward toward the left, front fender panel 34. It will be appreciated that in certain embodiments, movement of a die and/or panel can be driven by a press (not shown). In one embodiment, and as shown in FIG. 3, the die 46 can be substantially flat and the carrier 48 can include a thin film 49 for carrying ink 50 (e.g., thermoplastic ink) or another medium. The indicia 44 can be formed by the ink 50 and the ink 50 can bond with the left, front fender panel 34 upon hot stamping. The thin film 49 can be made from Mylar®, for example, or any of a variety of other suitable materials.

In another embodiment, a medium on the carrier 48 can be embossed by the die 46 onto the left, front fender panel 34 in a hot-stamping process, such that the indicia 44 can correspond to projections (not shown) on the die 46. However, it will be appreciated that a hot-stamping process can be conducted in any of a variety of other suitable configurations. As illustrated in FIG. 2, the carrier 48 can be associated with one or more rollers (e.g., 52, 53) to facilitate movement of the carrier 48 between the left, front fender panel 34 and the die 46 during the hot-stamping process. As illustrated in FIG. 2, one of the rollers can be a supply roller 52, which can provide the thin film 49 including the ink 50 thereon, and another roller can be a take-up roller 53, which can receive the thin film 49 after hot stamping.

Referring to FIGS. 3 and 8, the die 46 can include a stamping surface 54, a non-stamping surface 56, and a perimeter surface 58. As shown in FIG. 3, the stamping surface 54 and the perimeter surface 58 can cooperate to define an outer edge 60. In some embodiments, the stamping surface 54 of the die 46 can be a lower, stamping surface and the non-stamping surface 56 can be an upper, non-stamping surface. In such embodiments, the lower, stamping surface and the perimeter surface 58 can cooperate to define the outer edge 60. However, it will be appreciated that a stamping surface and a non-stamping surface can be arranged in any of a variety of suitable orientations. In some embodiments, the die 46 can further include a silicone rubber substrate 61 (FIGS. 2, 3, and 8), and in such embodiments, the silicone rubber substrate 61 can include the stamping surface 54, the non-stamping surface 56, and the perimeter surface 58. In some embodiments, and as illustrated in FIG. 3, the die 46 can further include a heating substrate 62. In such embodiments, the heating substrate 62 can be heated to facilitate heating the die 46 or portions thereof. For example, the heating substrate 62 can be in contact with the silicone rubber substrate 61, as shown in FIGS. 2-3, such that the heating substrate 62 can facilitate heating the silicone rubber substrate 61. Such heat flow from the heating substrate 62 to the silicone rubber substrate 61 is indicated generally by arrows (e.g., 63) in FIG. 3.

Referring to FIGS. 1 and 4, the left, front fender panel 34 can include an outer surface 64. The outer surface 64 can include an upper portion 66 (FIGS. 5-7) and a recessed portion 68, such that the recessed portion 68 can extend generally downwardly from the upper portion 66. As shown in FIGS. 5-7, the recessed portion 68 can include a contact surface 70 and a non-contact surface 72. During a hot-stamping process, as part of the manufacture of the left, front fender panel 34, the carrier 48 can come into contact with the contact surface 70 of the left, front fender panel 34 and the stamping surface 54 of the die 46, such that indicia (e.g., 44) can be applied to the contact surface 70 of the left, front fender panel 34. For example, as illustrated in FIG. 4, indicia 44 are shown to be on the contact surface 70. In some embodiments, and as illustrated in FIGS. 3 and 7, the contact surface 70 can be planar and can define an imaginary plane P1.

The non-contact surface 72 (FIGS. 3-7) of the left, front fender panel 34 can extend from the contact surface 70 to the upper portion 66 of the outer surface 64. As illustrated in FIGS. 3 and 5-7, the non-contact surface 72 can be shaped to define a channel 74. The portion 77 can be positioned adjacent to a perimeter 76 (FIGS. 3, 4, and 7) of the contact surface 70 and the channel 74 can at least partially surround the contact surface 70. In some embodiments, the channel 74 can extend completely around the contact surface 70 of the left, front fender panel 34. In some embodiments, at least a portion 77 (FIG. 7) of the non-contact surface 72 defining the channel 74 can have an arcuate, concave shape. However, a channel and/or a portion of a non-contact surface defining the channel can assume any of a variety of other suitable shapes and configurations.

The non-contact surface 72 of the left, front fender panel 34 can further include an inclined portion 78. As illustrated in FIG. 7, the inclined portion 78 can be outward of the perimeter 76 of the contact surface 70. The inclined portion 78 can extend from the portion 77 to the upper portion 66 of the outer surface 64 of the left, front fender panel 34. In some embodiments, and as illustrated in FIG. 7, the inclined portion 78 can be linear and can be inclined at an angle A1 ranging from about 100 degrees to about 150 degrees relative to the imaginary plane P1. However, it will be appreciated that a non-contact surface can assume any of a variety of suitable configurations such that the non-contact surface can be sufficiently spaced from a stamping surface of a die during a hot-stamping process.

As set forth above, indicia 44 can be hot stamped onto the contact surface 70 of the left, front fender panel 34. During the hot-stamping process, the stamping surface 54 of the die 46 and the contact surface 70 of the left, front fender panel 34 can be at least generally aligned with each other and the carrier 48 can be positioned between the stamping surface 54 of the die 46 and the contact surface 70 of the left, front fender panel 34, such that the carrier 48 can be in contact with each of the stamping surface 54 of the die 46 and the contact surface 70 of the left, front fender panel 34. As a result, indicia 44 can be applied from the carrier 48 to the contact surface 70 of the left, front fender panel 34 as the die 46 moves toward the left, front fender panel 34. In some embodiments, the stamping surface 54 of the die 46 and the contact surface 70 of the left, front fender panel 34 can be substantially centrally aligned with each other. In such embodiments, and as shown in FIG. 3, the stamping surface 54 and the contact surface 70 can be sized such that the outer edge 60 of the die 46 can extend beyond the perimeter 76 of the contact surface 70 of the left, front fender panel 34. Further, the outer edge 60 of the die 46 can be spaced from the non-contact surface 72 of the left, front fender panel 34, such that the outer edge 60 of the die 46 can be prevented from marking the left, front fender panel 34 during the hot-stamping process to form the indicia 44 on the contact surface 70 of the left, front fender panel 34.

In embodiments where the contact surface 70 of the left, front fender panel 34 is planar and defines the imaginary plane P1, the channel 74 can have an outer channel perimeter 80 (FIGS. 3 and 7). The outer channel perimeter 80 can be defined by an intersection of the imaginary plane P1 and the non-contact surface 72 of the left, front fender panel 34, and can be spaced from the perimeter 76 of the contact surface 70, as shown in FIG. 3. As illustrated in FIG. 7, the channel 74 can further have a channel width W_{C}, which can be a distance between the perimeter 76 of the contact surface 70 and the outer channel perimeter 80. While the channel width W_{C} can be substantially constant, it will be appreciated that a channel width can vary. In some embodiments, the channel 74 can further have a channel depth D, which can be a distance between the imaginary plane P1 and a bottom of the channel 74, as shown in FIG. 7. When the stamping surface 54 of the die 46 and the contact surface 70 of the left, front fender panel 34 are substantially centrally aligned with each other, the outer edge 60 of the die 46 can be positioned inwardly of, and spaced from, the outer channel perimeter 80 of the left, front fender panel 34, as illustrated in FIG. 3.

In some embodiments, each of the stamping surface 54 of the die 46 and the contact surface 70 of the left, front fender panel 34 can have a substantially rectangular shape, such that each of the stamping surface 54 of the die 46 and the contact surface 70 of the left, front fender panel 34 can have a length and width. In such embodiments, and where the channel width W_{C} is substantially constant, a length L₂ (FIGS. 3 and 8) of the stamping surface 54 of the die 46 can be greater than a length L₁ (FIG. 5) of the contact surface 70 of the left, front fender panel 34 and less than the length L₁ of the contact surface 70 of the left, front fender panel 34 plus twice the channel width W_{C}, such that the outer edge 60 of the die 46 can be prevented from contacting and marking the left, front fender panel 34 during the hot-stamping process to form the indicia 44 on the contact surface 70 of the left, front fender panel 34.

Similarly, a width W₂ (FIG. 8) of the stamping surface 54 of the die 46 can be greater than a width W₁ (FIG. 6) of the contact surface 70 of the left, front fender panel 34 and less than the width W₁ of the contact surface 70 plus twice the channel width W_{C}. However, it will be appreciated that a length L₂ can be greater than a length L₁ and a width W₂ can be greater than a width W₁, even where the channel width W_{C} is not substantially constant. Further, it will be appreciated that a stamping surface of a die and a contact surface of a panel can assume any of a variety of suitable corresponding shapes. For example, in another embodiment, a channel can have a substantially constant channel width and each of a stamping surface of a die and a contact surface of a panel can have a substantially circular shape, such that each of the stamping surface of the die and the contact surface of the panel can have a diameter. In such an embodiment, the diameter of the stamping surface of the die can be greater than the diameter of the contact surface of the panel and less than the diameter of the contact surface of the panel plus twice the channel width.

According to one embodiment, a method of forming indicia 44 on the left, front fender panel 34 can include forming the recessed portion 68 on the outer surface 64 of the left, front fender panel 34. The method can further include positioning the carrier 48 between the contact surface 70 of the left, front fender panel 34 and the stamping surface 54 of the die 46. The method can also include hot stamping the indicia 44 onto the contact surface 70 of the left, front fender panel 34. Hot stamping can include at least generally aligning the stamping surface 54 of the die 46 with the contact surface 70 of the left, front fender panel 34 and moving the die 46 and the left, front fender panel 34 relative to each other (i.e., by moving one or both of the die 46 and the left, front fender panel 34) such that the carrier 48 can be in contact with each of the stamping surface 54 of the die 46 and the contact surface 70 of the left, front fender panel 34. The indicia 44 can be applied from the carrier 48 to the contact surface 70 of the left, front fender panel 34. The method can further include configuring the die 46 such that the outer edge 60 of the die 46 can be spaced from the non-contact surface 72 and the outer edge 60 of the die 46 can be prevented from marking the left, front fender panel 34 during the hot stamping.

In some embodiments where each of the stamping surface 54 of the die 46 and the contact surface 70 of the left, front fender panel 34 have a substantially rectangular shape, a length and width, and the channel width W_{C} is substantially constant, configuring the die 46 can include sizing the stamping surface 54 of the die 46 such that the length L₂ of the stamping surface 54 of the die 46 can be greater than the length L₁ of the contact surface 70 of the left, front fender panel 34 and less than the length L₁ of the contact surface 70 of the left, front fender panel 34 plus twice the channel width W_{C}. In such embodiments, configuring the die 46 can further include sizing the stamping surface 54 of the die 46 such that the width W₂ of the stamping surface 54 of the die 46 can be greater than the width W₁ of the contact surface 70 of the left, front fender panel 34 and less than the width W₁ of the contact surface 70 plus twice the channel width W_{C}.

By configuring the die 46 such that the outer edge 60 of the die 46 can be spaced from the non-contact surface 72 of the left, front fender panel 34, the outer edge 60 of the die 46 can be prevented from marking the left, front fender panel 34 during the hot-stamping process. Without such spacing between the outer edge 60 of the die 46 and the non-contact surface 72 of the left, front fender panel 34, the outer edge 60 or some other portion of the die 46 might be allowed to come into direct contact with the non-contact surface 72 where the die 46 can leave undesirable marks and/or imperfections thereon.

While a method of forming indicia (e.g., 44) on a left, front fender panel (e.g., 34) of a vehicle (e.g., 10) has been described, such a method can be used with any of the panel of a vehicle (e.g., 10). Also, the indicia can be located in any of a variety of places on a panel, e.g., a fender panel, of a vehicle. The indicia can be used to provide various information, for example, warnings, instructions, manufacturer information, etc.

While various embodiments have been illustrated by the foregoing description and have been described in considerable detail, it is not intended to restrict or in any way limit the scope of the appended claims to such detail. Additional modifications will be readily apparent to those skilled in the art.

What is claimed is:

1. A die in combination with a panel, the combination comprising:
a die comprising a stamping surface, a non-stamping surface, and a perimeter surface, the stamping surface and the perimeter surface cooperating to define an outer edge; and
a panel comprising an outer surface, the outer surface comprising a recessed portion, the recessed portion comprising a contact surface, indicia on the contact surface, and a non-contact surface, the contact surface having a perimeter, the non-contact surface defining a channel, the channel being positioned adjacent the perimeter of the contact surface and at least partially surrounding the contact surface;
wherein when the stamping surface of the die and the contact surface of the panel are at least generally aligned, the outer edge of the die extends beyond the perimeter of the contact surface of the panel and the outer edge of the die is spaced from the non-contact surface of the panel, such that the outer edge of the die is prevented from marking the panel during a hot-stamping process to form the indicia on the contact surface of the panel.

2. The combination of claim 1, wherein:
the stamping surface of the die comprises a lower, stamping surface;
the non-stamping surface of the die comprises an upper, non-stamping surface; and
the channel defined by the non-contact surface of the panel extends completely around the contact surface of the panel.

3. The combination of claim 2, wherein:
the contact surface of the panel is planar and defines an imaginary plane;
the channel has an outer channel perimeter, the outer channel perimeter being defined by an intersection of the imaginary plane and the non-contact surface of the panel;
the outer channel perimeter is spaced from the perimeter of the contact surface; and
when the lower, stamping surface of the die and the contact surface of the panel are at least generally aligned, the outer edge of the die is positioned inwardly of the outer channel perimeter of the panel.

4. The combination of claim 3, wherein the channel has a channel width, the channel width being a distance between the perimeter of the contact surface of the panel and the outer channel perimeter.

5. The combination of claim 4, wherein:
each of the lower, stamping surface of the die and the contact surface of the panel has a substantially rectangular shape, such that each of the lower, stamping surface and the contact surface has a length and width;
the channel width is substantially constant; and
the length of the lower, stamping surface of the die is greater than the length of the contact surface of the panel and is less than the length of the contact surface of the panel plus twice the channel width.

6. The combination of claim 5, wherein the width of the lower, stamping surface of the die is greater than the width of the contact surface of the panel and is less than the width of the contact surface of the panel plus twice the channel width.

7. The combination of claim 3, wherein the non-contact surface of the panel comprises an inclined portion, the inclined portion being linear and inclined at an angle ranging from about 100 degrees to about 150 degrees relative to the imaginary plane.

8. The combination of claim 7, wherein the inclined portion of the panel is outward of the perimeter of the contact surface of the panel.

9. The combination of claim 1, wherein a portion of the non-contact surface defining the channel has an arcuate, concave shape.

10. The combination of claim 9, wherein:
the contact surface of the panel is planar and defines an imaginary plane; and
the non-contact surface of the panel comprises an inclined portion, the inclined portion being linear and inclined at an angle ranging from about 100 degrees to about 150 degrees relative to the imaginary plane.

11. The combination of claim 1, wherein the die further comprises:
a silicone rubber substrate that comprises the stamping surface; and
a heating substrate in contact with the silicone rubber substrate.

12. The combination of claim 1, wherein:
the outer surface of the panel further comprises an upper portion, the recessed portion extending generally downwardly from the upper portion; and
the panel comprises a fender panel of a body of a vehicle.

13. A die in combination with a panel, the combination comprising:
a die comprising a lower, stamping surface, an upper, non-stamping surface, and a perimeter surface, the lower, stamping surface and the perimeter surface cooperating to define an outer edge; and
a panel comprising an outer surface, the outer surface comprising an upper portion and a recessed portion, the recessed portion extending generally downwardly from the upper portion and comprising a contact surface, indicia on the contact surface, and a non-contact surface, the contact surface having a perimeter, the non-contact surface defining a channel, the channel being positioned adjacent the perimeter of the contact surface and completely surrounding the contact surface; wherein
each of the lower, stamping surface of the die and the contact surface of the panel has a substantially rectangular shape, such that each of the lower, stamping surface and the contact surface has a length and width;
the contact surface is planar and defines an imaginary plane;
the non-contact surface comprises an inclined portion, the inclined portion being linear and inclined at an angle ranging from about 100 degrees to about 150 degrees relative to the imaginary plane; and
the channel has an outer channel perimeter and a channel width, the outer channel perimeter being defined by an intersection of the imaginary plane and the non-contact surface, the outer channel perimeter being spaced from the perimeter of the contact surface, the channel width being a distance between the perimeter of the contact surface and the outer channel perimeter, the channel width being substantially constant.

14. The combination of claim 13, wherein:
the length of the lower, stamping surface of the die is greater than the length of the contact surface of the panel and is less than the length of the contact surface of the panel plus twice the channel width, and the width of the lower, stamping surface of the die is greater than the width of the contact surface of the panel and is less than the width of the contact surface plus twice the channel width, such that the outer edge of the die is prevented from marking the panel during a hot-stamping process to form the indicia on the contact surface of the panel; and
the die further comprises:
a silicone rubber substrate that comprises the lower, stamping surface, the upper, non-stamping surface, and the perimeter surface; and
a heating substrate; wherein
the heating substrate contacts the upper, non-stamping surface of the silicone rubber substrate.

15. A method of forming indicia on a panel, the method comprising:
forming a recessed portion on an outer surface of a panel, the recessed portion comprising a contact surface and a non-contact surface, the non-contact surface defining a channel, the channel being positioned adjacent the contact surface and at least partially surrounding the contact surface;
positioning a carrier between the contact surface of the panel and a stamping surface of a die, the contact surface of the panel having a perimeter, the die comprising an outer edge;
hot stamping indicia onto the contact surface of the panel, the hot stamping comprising at least generally aligning the stamping surface of the die with the contact surface of the panel and moving the die and the panel relative to each other such that the carrier is in contact with each of the stamping surface of the die and the contact surface of the panel and indicia is applied from the carrier to the contact surface of the panel; and
configuring the die such that the outer edge of the die is spaced from the non-contact surface of the panel and the outer edge of the die is prevented from marking the panel during the hot stamping.

16. The method of claim 15, wherein forming comprises forming the channel completely around the contact surface.

17. The method of claim 16, wherein:
the stamping surface of the die comprises a lower, stamping surface;
the contact surface of the panel is planar, has a perimeter, and defines an imaginary plane;
each of the lower, stamping surface and the contact surface has a substantially rectangular shape, such that each of the lower, stamping surface and the contact surface has a length and width;
the channel has an outer channel perimeter and a channel width, the outer channel perimeter being defined by an intersection of the imaginary plane and the non-contact surface and spaced from the perimeter of the contact surface, the channel width being a distance between the perimeter of the contact surface and the outer channel perimeter, the channel width being substantially constant; and
the configuring comprises sizing the lower, stamping surface of the die such that the length of the lower, stamping surface of the die is greater than the length of the contact surface of the panel and is less than the length of the contact surface plus twice the channel width.

18. The method of claim 17, wherein the configuring further comprises sizing the lower, stamping surface of the die such that the width of the lower, stamping surface of the die is greater than the width of the contact surface of the panel and is less than the width of the contact surface plus twice the channel width.

19. The method of claim 15, wherein the die further comprises a silicone rubber substrate that comprises the lower, stamping surface, and a heating substrate in contact with the silicone rubber substrate; and wherein
the method further comprises heating the silicone rubber substrate with the heating substrate.

20. The method of claim 15, wherein:
the outer surface of the panel further comprises an upper portion, the recessed portion extending generally downwardly from the upper portion; and
the panel comprises a fender panel of a body of a vehicle.
